(19) United States
(12) Patent Application Publication
(10) Pub. No.: US 2021/0092944 A1
(43) Pub. Date: Apr. 1, 2021

(54) FISHING ROD STATION

(71) Applicant: Abel David Florez, Artesia, NM (US)

(72) Inventor: Abel David Florez, Artesia, NM (US)

(21) Appl. No.: 16/590,325

(22) Filed: Oct. 1, 2019

(51) Int. Cl. A01K 97/10; A01K 97/04

(52) U.S. Cl. CPC A01K 97/10; A01K 97/06; A01K 97/04

(57) ABSTRACT

A fishing rod station is presented. The fishing rod station has front portion which has a first leg, a second leg and a table. The fishing rod table has a rear portion which has a first leg, a second leg, and a table. Also, the fishing rod table has a middle portion which has an upper right arm, a right base arm, an upper left arm, a left base arm, and a table. The right base arm securely coupled to the first leg of the front portion and securely coupled to the first leg of the rear portion. The left base arm securely coupled to the second leg of the front portion and securely coupled to the second leg of the rear portion. The upper right arm of the middle portion securely coupled to the first leg of the front portion and securely coupled to the first leg of the rear portion. The table of the middle portion securely coupled to the right base arm of the middle portion and securely coupled to the left base arm of the middle portion. The station has a collapsible bait cutting table coupled to the table of the rear portion. Further, the station has a storage compartment, being the table of the middle portion, for storing tool, phones, supplies, etc. and a cup holder coupled to the table of the rear portion. The height is generally thirteen (13) to nineteen (19) inches which is knee height to aid in ease and speed of access to the fishing rods.

### FIELD OF THE INVENTION

This invention relates to fishing rod holders. More particularly, it relates to fishing rod holders with bait station.

### BACKGROUND

Currently a person going fishing has to store a number of items, including a folding chair, hooks, rods, rod holders, and flashlights or head lamps. The fisherman would have to carry all of this gear to and from the fishing site, as well as set the gear up on the site once they have reached the site.

Existing rod holders require the holders to be driven into the solid earth, resulting in rods being placed too far from the water and resulting in missed bites. These holders are also non-adjustable and cannot be placed in locations without soil present. Existing rod holders are further subject to missed catches on windy days when it is difficult to tell when a catch is on the line.

Further, the bait needs to be prepared for fishing. There is no current prior art that combines a bait preparing area and a fishing rod holder for a person desiring to fish. This problem and others are addressed by this application.

### BRIEF DESCRIPTION OF THE DRAWINGS

FIG. 1 shows an illustrated view of an exemplary fishing rod station.

FIG. 2 shows an illustrated view of the exemplary fishing rod station in a collapsed state.

FIG. 3 shows an illustrated view of the exemplary fishing rod station with fishing rods.

FIG. 4 shows an illustrated view of the exemplary fishing rod station with a notched rod holder.

FIG. 5 shows an illustrated view of the exemplary fishing rod station with extended bait cutting table.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

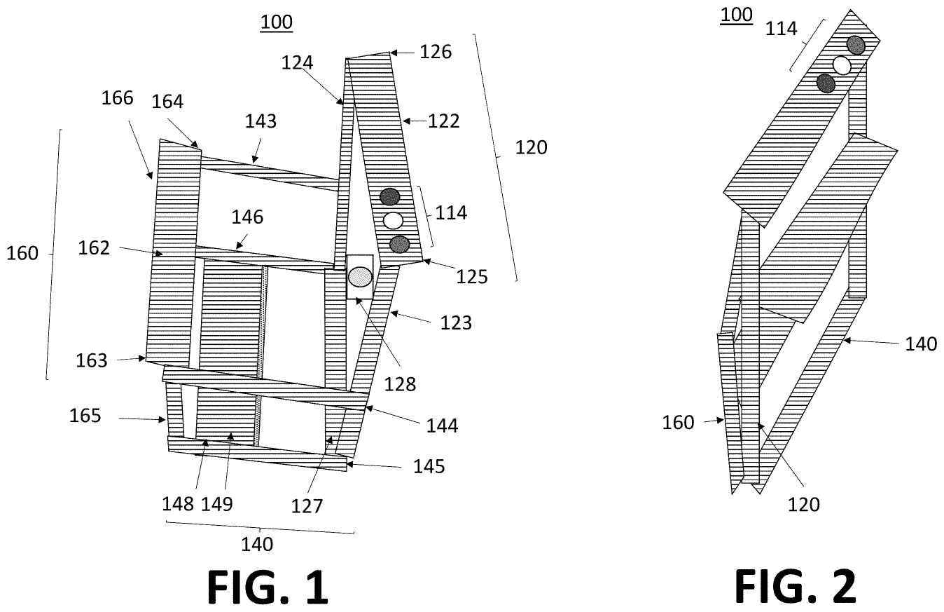

Referring to FIG. 1, shows the components of an exemplary fishing rod station 100. The fishing rod station 100 is useful to ease the burden of bending down to push rod holders into the rocky ground, alleviate the slanting station when on a slope, and has a bait cutting table. The fishing rod station 100 is preferably made from a plastic material, but may be made from other materials which are light weight and durable such as aluminum, wood, etc.

Preferably, the height of the fishing rod station 100 is thirty (30) inches, twenty (20) inches in length, and twenty (20) inches in length. The shape is preferably square, but may be any shape one of ordinary skill may desire. The shape being preferably of the size of twenty (20) inches in length, twenty (20) inches in width, and twelve (12) inches in depth. The fishing rod station 100 further preferably has a thirty (30) inch top on the front of the fishing rod station 100.

The fishing rod station 100 has a front side 120, a middle portion 140, and a rear portion 160.

The front portion 120 of the fishing rod station 100 is useful for having up to three fishing rods rest on a front table 122. The front table 122 has at least three lamps 114, the lamps 114 allow for a soft light to be emitted and others to know where the fishing rod station 100 is located at night. The lamps 114 are preferably light emitting diode lamps, but may be any type and kind of lamp such as LCD, cathode, etc.

The front table 122 has a first leg 123 and a second leg 124. The first leg 123 is couple to a first side 125 of the front table 122 and the second leg is coupled to a second side 126 of the front table 122. The first leg 122 and the second leg 124 are coupled to a front base 127.

The front table 122 further has a back lamp 127 coupled to the front table 122. The back lamp 128 provide a light for the rear portion 160 of the fishing rod station 100.

The rear portion 160 of the fishing rod station 100 is useful to provide a resting place for the butts of the fishing rods. The rear portion 160 of the fishing rod station 160 is of a lower height than the front portion 120 of the fishing rod station 100 and is closer to the angler.

The rear portion 160 has a rear table 162. The rear table 162 has a first side 163 and a left side 164. The rear portion 160 further has a first leg 165 and a second leg 166. The first leg 165 is coupled to the first side 163 of the rear table 162. The second leg 166 is coupled to the second side 164.

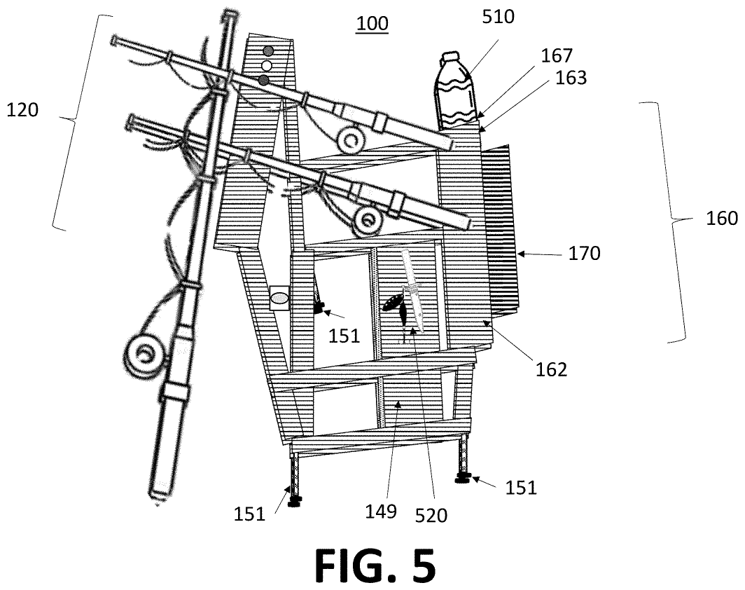

The rear portion 160 may further have a bait cutting station (not shown) (see FIG. 5, 170). The rear table 162 of the rear portion 160 of the fishing rod table 100 is preferably between thirteen (13) inches and nineteen (19) inches in height, though other sizes are also contemplated. The preferable height is considered to be knee high and allows for easier and faster access to the fishing poles when a fish strikes the bait helping to prevent missed strikes. Optionally, the first side 163 of the rear portion 164 of the fishing rod station 100 has a cup holder (FIG. 5 167).

The middle portion 140 of the fishing rod station 100 couples the front portion 120 of the fishing rod station 100 to the rear portion 160 of the fishing rod station 100. The middle portion 140 has a first upper arm 142, a second upper arm 143, first base arm 144, a second base arm 145 and a storage compartment 146.

The first upper arm 142 of the middle portion 140 of the fishing rod station 100 is coupled to the first leg 165 of the rear portion 160 of the fishing rod station 100 and to the first leg 123 of the front portion 120 of the fishing rod station 100. The second upper arm 143 of the middle portion 140 of the fishing rod station 100 is coupled to the second leg 166 of the rear portion 160 of the fishing rod station and to the second leg 124 of the front portion 120 of the fishing rod station 100.

The first base arm 144 of the middle portion 140 of the fishing rod station 100 is coupled to the first leg 165 of the rear portion 160 of the fishing rod station 100 and to the first leg 123 of the front portion 120 of the fishing rod station 100. The second base arm 145 of the middle portion 140 of the fishing rod station 100 is coupled to the second leg 166 of the rear portion 160 of the fishing rod station and to the second leg 124 of the front portion 120 of the fishing rod station 100.

The storage compartment 146 is useful for storing tools and other items a fisherman would need during a fishing trip. The tools and other items may include, but not limited to, knives, pliers, phone, tools, tackle, etc. The storage compartment has a first side 147, a second side 148 and a table 149. The tools and other items would be placed on the table for safe keeping.

The table 149 has a first side 150 and a second side 151. The first side 150 of the table 149 of storage compartment 146 is coupled to the first base arm 144. The second side 150 of the table 149 of the storage compartment 146 is coupled to the second base arm 145 of the middle portion 140 of the fishing rod station 100.

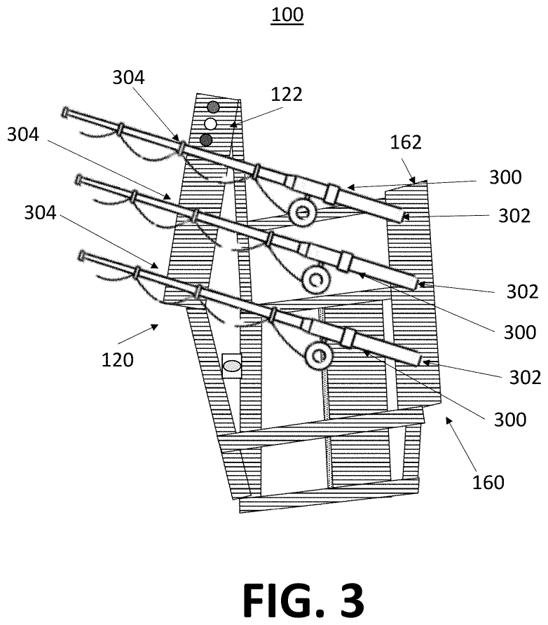

The first base arm 144 of the middle portion 140 of the fishing rod station 100 may further have one or more legs (Not shown) (See FIG. 3 151). The second base arm 145 of the middle portion 140 of the fishing rod station 100 may have the one or more legs (Not shown) (See FIG. 3, 151). The one or more legs 151 are adjustable. The one or more legs 151 on the front portion 120 of the fishing rod station 100 are preferably adjustable between twenty (20) inches and thirty-four (34) inches. The adjustable one or more legs 151 allow for the fishing rod station 100 to be leveled when the land is sloped, which is common when fishing near a lake.

Moving now to FIG. 2, the fishing rod station 100 of FIG. 1 is shown in a folded stage. The folded stage for the fishing rod station 100 is useful to transport and/or store the fishing rod station 100. The use of plastic material, or other light weight materials, allow a person to easily move the fishing rod station 100 to a desired location. When folded, the fishing rod station 100 is shown with the front portion folded at the coupling of the first base arm 144 of the middle portion 140 and the first leg 123 of the front portion 120 of the fishing rod station 100 and at the coupling of the second base arm 145 of the middle portion 140 of the fishing rod station 100 and the second leg 124 of the front portion 120 of the fishing rod station 100.

The fishing rod station 100 is also shown with the rear portion 160 folded at the coupling of the first base arm 144 of the middle portion 140 and the first leg 165 of the rear portion 160 of the fishing rod station 100 and at the coupling of the second base arm 145 of the middle portion 140 of the fishing rod station 100 and the second leg 166 of the rear portion 160 of the fishing rod station 100.

The middle portion 140 of the fishing rod station 100 is not visible in the FIG. 2 when the fishing rod station 100 is in a folded stage.

Moving now to FIG. 3, an illustrated view of the fishing rod station 100 with the fishing poles 300 positioned on it is presented. Three fishing poles 300 are being utilized by an angler. The angler positions the fishing rod station 100 and levels the fishing rod station 100. The angler cast out a line from each of the three fishing poles 300 The angler positions the three fishing poles 300 where a butt 302 of each of the fishing poles 300 is placed on the rear table 162. A tip 304 of each of the fishing poles 300 is placed on the front table 122. The angler then lets the fishing poles rest on the fishing rod station 100 until a fish bite.

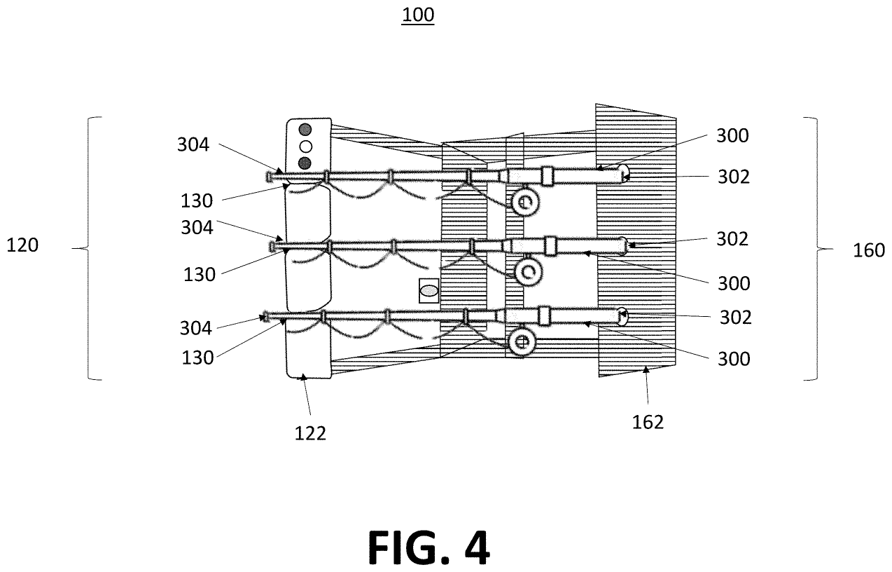

Moving now to FIG. 4, an illustrated view of the fishing rod station 100 with a notched rod holder is presented. Three fishing poles 300 are being utilized by an angler. The front table 122 of the front portion 120 of the fishing rod station 100 has notches 130 to better secure the fishing poles when placed on the fishing rod station 100. The angler positions the fishing rod station 100 and levels the fishing rod station 100. The angler cast out a line from each of the three fishing poles 300. The angler positions the three fishing poles 300 where a butt 302 of each of the fishing poles 300 is placed on the rear table 162. A tip 304 of each of the fishing poles 300 is placed into the notches 130 of the front table 122 of the front potion 120 of the fishing rod table 100. The angler then lets the fishing poles rest on the fishing rod station 100 until a fish bite.

FIG. 5 illustrates the use of the compartment table 147. In addition, only those items new or being utilized will be discussed.

The compartment table 147 is useful for storing items 520 such as a fishing lure and knife 510. The items are stored in a safe area where only access is when someone reaches into the viewable area of the compartment table 147 to place or remove the items. In addition, the cup holder 167 is coupled to the first side 163 of the rear table 162 of the rear portion 160 of the fishing rod station 100. The cup holder 167 has a bottle 510 stored. The bottle 520 may be replaced with any type of item such as a can, a cup, a glass, etc. Further, coupled to the table is a bait station 170. The bait station 170 is useful when cutting bait to be put onto a hook of a fishing pole.

The fishing rod station 100 further has one or more legs 151. The legs 151 may be made of any material such as iron, aluminum, wood, plastic, etc. The legs 151 are adjustable in that the height of the legs 151 may be shortened or lengthened depending on the terrain or the desire of the angler. The legs 151 are generally placed on each of the four corners of the fishing rod station 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A fishing rod station, the station comprising:
a front portion, the front portion having a first leg, a second leg and a table;
a rear portion, the rear portion having a first leg, a second leg, and a table;
a middle portion, the middle portion having a upper right arm, a right base arm, an upper left arm, a left base arm, and a table;
the right base arm securely coupled to the first leg of the front portion and securely coupled to the first leg of the rear portion;
the left base arm securely coupled to the second leg of the front portion and securely coupled to the second leg of the rear portion;
the upper right arm of the middle portion securely coupled to the first leg of the front portion and securely coupled to the first leg of the rear portion; and
the table of the middle portion securely coupled to the right base arm of the middle portion and securely coupled to the left base arm of the middle portion.

2. The station of claim 1, wherein the station being made of a plastic material.

3. The station of claim 1, wherein the table of the middle portion being a storage compartment.

4. The station of claim 3, wherein the storage compartment being for storing fishing tools.

5. The station of claim 3, wherein the storage compartment being for storing a cell phone.

6. The station of claim 1, further comprising:
one or more legs, wherein the one or more legs are securely coupled to each of the corners of the bottom of the station.

7. The station of claim 6, wherein the one or more legs being adjustable.

8. The station of claim 6, wherein the one or more legs being adjustable between twenty (20) inches and thirty-four (34) inches on the front portion of the station.

9. The station of claim 6, wherein the station being level based on the adjusting of the adjustable one or more legs.

10. The station of claim 1, further comprising:
at least three lamps, the three lamps being securely coupled to the table of the front portion of the station; and
the at least three lamps being at least one color.

11. The station of claim 10, wherein the at least one-color being red.

12. The station of claim 10, wherein the at least one color being red and white and blue.

13. The station of claim 1, further comprising:
a cup holder, the cup holder being securely coupled to the table of the rear portion.

14. The station of claim 11, wherein the cup holder having a cup.

15. The station of claim 1, wherein the station being thirty (30) inches in height, twenty (20) inches in length and twenty (20) inches in width.

16. The station of claim 1, wherein a shape of the station being twenty (20) inches in length, twenty (20) inches in width, and twelve (12) inches in depth and further having a top, the top being thirty (30) inches.

17. The station of claim 1, further comprising:
a bait cutting table, wherein the bait cutting table of the rear portion being hingedly coupled to the table of the rear portion.
